(19) United States
(12) Patent Application Publication
(10) Pub. No.: US 2023/0078070 A1
(43) Pub. Date: Mar. 16, 2023

(54) SMART BUILDING ANALYTICS NETWORK AND PLATFORM

(71) Applicant: Red Bison Technology Group, LLC, Bellevue, WA (US)

(72) Inventors: David CAHOON, Bellevue, WA (US); Graeme JONES, Bellevue, WA (US)

(21) Appl. No.: 17/821,965

(22) Filed: Aug. 24, 2022

Related U.S. Application Data
(60) Provisional application No. 63/244,984, filed on Sep. 16, 2021.

(51) Int. Cl. G06F 21/62

(52) U.S. Cl. CPC G06F 21/629

(57) ABSTRACT

Technologies are described herein to an SDK for a smart building platform. The smart building platform includes an application programming interface (API) that includes permissions to upload data for storage in a smart building cloud portal via the subscription-based network-as-a-service and access data stored in the smart building cloud portal via a subscription-based network as a service. The accessed data includes the uploaded data, data uploaded by another source, analyzed data uploaded from multiple sources, or visual representations thereof.

### TECHNICAL FIELD

The embodiments described herein pertain generally to smart building technologies and the provision of secure data brokerage therefor.

### BACKGROUND

Building owners and managers have typically managed data pertaining to performance of their properties in terms of occupancy, which may include tenant-based revenue. However, as implementation of regulations based on, e.g., environmental concerns, increase, these owners and managers are being forced to take a broader view of property performance.

### SUMMARY

In one example embodiment, a computer-readable medium stores executable instructions that, upon execution, cause a processor to receive an activation request and secure access to one or more interface busses and corresponding secure access to a smart building platform for the subscribing entity in accordance with one or more application programming interfaces (APIs) corresponding to an authorized software development kit (SDK). The APIs provide permissions to upload data for to an authorized smart building cloud portal endpoint via one or more of the interface busses and to access data stored in the smart building cloud portal via a subscription-based network as a service. The accessed data includes the uploaded data, data uploaded by another source, analyzed data uploaded from multiple sources, or visual representations thereof.

In another example embodiment, a computer-readable medium for a smart building development platform has computer-executable components stored therein. The computer-executable components include an activator to secure access to one or more interface busses and corresponding secure access to a smart building platform for the subscribing entity in accordance with one or more application programming interfaces (APIs) corresponding to an authorized software development kit (SDK), a controller to control access to data on the smart building platform via one or more of the secured interface busses, an analyzer to execute programmed analysis of the uploaded data, and a visualizer to produce visualizations of the analyzed data.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a block diagram representing an example system by which smart building data may be accessed aggregated, analyzed, and disseminated, arranged in accordance with at least some embodiments described and recited herein;

FIG. 2 shows a block diagram representing another configuration of example system by which smart building data may be accessed aggregated, analyzed, and disseminated, arranged in accordance with at least some embodiments described and recited herein;

FIG. 3 shows an example operating system by which smart building data may be accessed aggregated, analyzed, and disseminated, arranged in accordance with at least some embodiments described and recited herein; and

FIG. 4 shows an example operational flow by which smart building data may be accessed aggregated, analyzed, and disseminated, arranged in accordance with at least some embodiments described and recited herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

As property owners take a broader view of property performance and success, real-time collection and analysis of data may increase in importance. Stakeholders are left with the challenges of not only identifying pertinent data to collect and how to use such data once aggregated but also doing so in a secure manner. Stakeholders may include, but not be limited to, property owners and/or managers as well as service providers. Non-limiting examples of such service providers may include building management providers, heating/ventilation/air conditioning (HVAC) system providers, water providers, electricity providers, internet service providers, security providers, police, fire and rescue, etc.

In the present description and recitation, the following terms may be used, in addition to their accepted meaning, as follows:

A software development kit (SDK) may include, but not be limited to a development tool by which third-party vendors, particularly vendors in the technical field of services including the Internet-of-Things (IOT), may utilize to provide additional capabilities upon a smart building network and platform.

As described and recited herein, an SDK may make available numerous application programming interfaces (APIs) by which the aforementioned third-party vendors may access a secure portal to store, retrieve, and otherwise customize data pertaining to a particular smart building or even a plurality thereof.

A data streaming bus may refer to a secured high-speed data bus that is designed, programmed, or configured to route collected and/or analyzed data to and from instances of applications on a similarly secured platform having subscribed accessed to the data.

A network as a service may provide a data end-point for subscribers or registered applications to connect to secured data streams from subscribed or otherwise authorized systems.

A cloud store may refer to a data persistence mechanism to store a variety of smart-building-related data. The storage may be structured or unstructured, and may also be organized in a variety of ways related to time, relationship, etc.

Property analytics may refer to the collection of desired, pertinent data, in the cloud store via a secure data streaming bus, for aggregation and analysis utilizing algorithms intended to produce and/or implement recommendations for improving operations on a given property or properties.

As referenced, described, and/or recited herein, performance may pertain to the allocation of service resources to one or more buildings, the cost thereof, the usage thereof, etc.

Visual presentation may refer to a web-based visualization tool that may provide an actionable representation of data that may be customized based on a receiving user’s role and authorization. The data may be collected and analyzed via a secure data streaming bus or network as a service, and the output thereof may be regarded as property analytics that presents, e.g., past and current performance, projected performance, and recommendations to achieve or even improve upon the current and projected performance. Accordingly, based on such visualization, the platform may provide tools for authorized or automated responses to the analysis. Such responses may be implemented in the form a textual or visual recommendation or as an automated action pertaining to the allocation and/or usage of resources in one or more of the aforementioned buildings.

The embodiments described and recited herein pertain to methods, programs, systems, apparatuses, and components for the provision and implementation of a platform that provides robust collection, aggregation, and analysis of smart-building-related data. The platform SDK that includes an open API library.

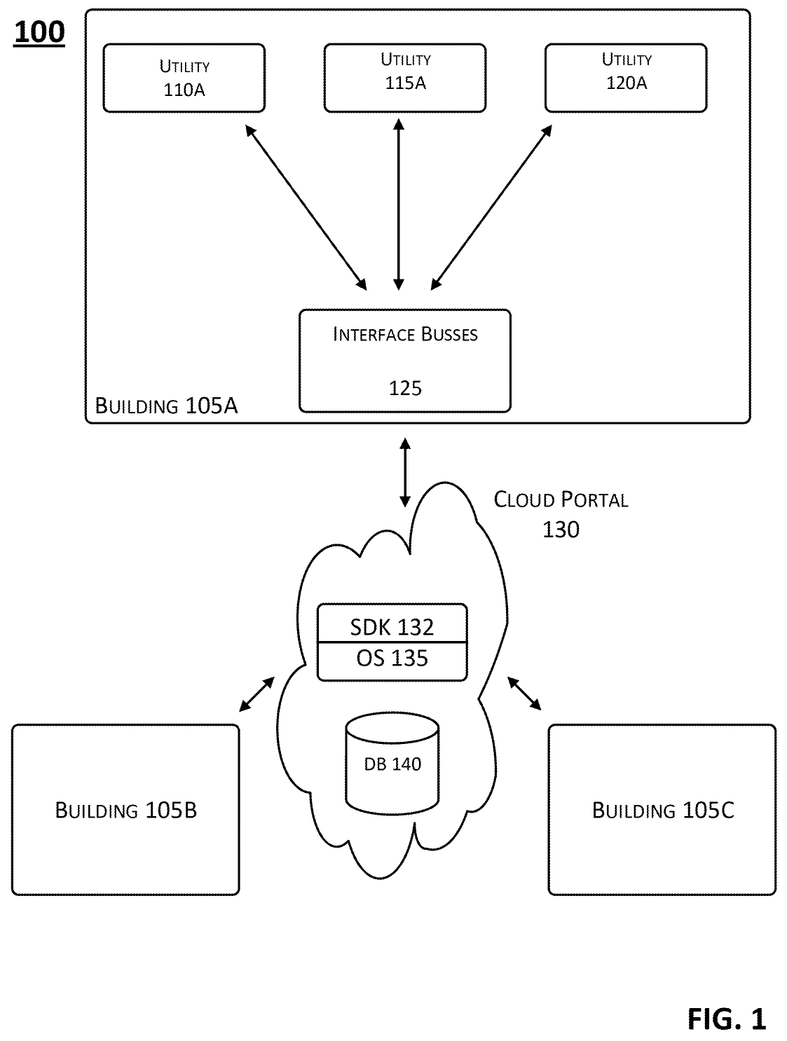

FIG. 1 shows a block diagram representing an example system by which smart building data may be stored, accessed, aggregated, analyzed, and disseminated, arranged in accordance with at least some embodiments described and recited herein. As depicted, system 100 includes at least plural buildings 105A, 105B, and 105C; and cloud portal 130. Building 105A, as an example only, may be provided services 110A, 115A, and 120B, and interface busses 125. Cloud portal 130, as an example only, may include SDK 132, Operating System (OS) 135, and database 140. Although illustrated as discrete entities and/or components, the features shown and described may be divided into additional entities and/or components, combined into fewer entities and/or components, or eliminated altogether while being contemplated within the scope of the disclosed subject matter.

Buildings 105A, 105B, and 105C may refer to buildings for which data corresponding to service providers may be aggregated, analyzed, and disseminated via applications on a common platform, via a secured network of busses. Unless context otherwise requires, reference herein may be to building 105 in the singular or buildings 105 in the plural. Further, the example embodiments of a smart analytics network platform, as described and recited herein, are not limited in quantity to just three buildings, which is depicted for descriptive purposes only.

Building 105 may refer to a structure, non-limiting examples of which may include an office building, a school, a hospital, a gym, etc., having a common network over which all service providers 110, 115, and 120 may transceive data regarding dispensation of the respective services.

Services 110A, 115A, and 120A may refer to services that may be dispensed to building 105 and for which corresponding data may be accessed, aggregated, and disseminated over the secured common network. Non-limiting examples of such services may include any combination or permutation of building management services; HVAC; water; electricity; communication networks; security monitoring, which may include monitoring the number of people entering and exiting a particular building, monitoring credentials of the people entering and exiting the building, etc.

Further, non-limiting examples of services 110A, 115A, and 120A may correspond to building management. As non-limiting examples, any of the aforementioned services may correspond to building usage including, but not limited to, occupancy, parking capacity, room temperature, corridor traffic, or a variety of other parameters that may be counted or monitored using various sensor technologies.

Services 110A, 115A, and 120A may correspond to building 105A, and buildings 105B and 105C may have similar arrangements of services, though not necessarily identical for each of buildings 105. Further, the example embodiments of a smart building network and analytics platform, as described and recited herein, are not limited in quantity to services 110, 115, and 120, which are depicted for descriptive purposes only.

Interface busses 125 may refer to a secure high-speed data bus implemented as a conduit for a network that may include one or more of the Internet, an intranet, or at least portions of one or more local area networks (LANs), with data communication implemented by either of a wired or wireless link.

Interface busses 125 may be implemented as secure data streams to facilitate a network-as-a-service, in accordance with various embodiments of a smart-building network and analytics platform, which may provide data end points for applications built on the platform. Endpoints for such data streams may include, but are not limited to, cloud portal 130, buildings 105, and any one or more of providers of services 110, 115, and 120, which may be disposed external to any of buildings 105. That is, while provided services and corresponding data may pertain to a particular one of buildings 105, data regarding provision of such services to any one or more of buildings 105 may be collected and/or controlled off-site relative to the buildings 105. Alternatively, data regarding provision of such services to any one or more of buildings 105 may be collected and/or controlled at a designated one of buildings 105.

As depicted in the non-limiting example of FIG. 1, interface busses 125 may be disposed within building 105A. Accordingly, interface busses 125 may comply with a particular network architecture implemented by a management entity of building 105A.

Further, via respective ones of interface busses 125, data may be transmitted and/or received by any of a variety of computing devices, such as a server, a desktop personal computer (PC) or network-associated device such as, but not limited to, a smartphone, tablet, laptop computer, etc. corresponding to any of buildings 105, and/or services 110, 115, and 120. Further still, data may be transmitted and/or received, via respective ones of interface busses 125, to BMS (building management systems) and loT (Internet of Things) devices, which are embedded with sensors, software, and/or other technologies for the exchange of data over the Internet.

Cloud portal 130 may refer to a secure web-based interface by which a subscriber or authorized entity may access database 140 for storage of data or for access to data therefrom, via a secured network connection.

Database 140 may refer to a data persistence mechanism implemented by one or more network servers or application servers designed, configured, or programmed to receive content from and deliver content to subscribing or otherwise authorized computing devices by way of at least one of interface busses 125. Such content may include a variety of data types capable of being structured and unstructured, time-series data, graph-oriented data, relational data, etc., to be stored to and accessed from database 140.

Access to database 140, via cloud portal 130, may be subscription-based. Therefore, any entity among buildings 105, and/or services 110, 115, and 120, may procure SDK 132 via a connection to a marketplace.

SDK 132 may refer to a development toolkit for third-party vendors among, e.g., buildings 105, and/or services 110, 115, and 120, to not only access database 140 via cloud portal 130, but also to provide additional data-centric capabilities on top of operating system 135.

Accordingly, SDK 132 may make available to subscribing third-party vendors a library of application programming interfaces (APIs) that are compatible with respective system architectures of the third-party vendors. As a non-limiting example, SDK 132 may include an API by which water utility providers are subscribed to a particular one of interface busses 125 to access cloud portal 130 and thereby interact with database 140. SDK 132 may similarly include separate APIs for electricity providers, internet service providers, security providers, police, fire and rescue, etc., to provide secure network access to cloud portal 130 and, e.g., database 140.

Thus, by the example embodiments of a smart building analytics platform, as described and recited herein, permutations of data may be aggregated, analyzed, and/or visualized. As non-limiting examples, cross-sectional data for services 110A, 115A, and 120A may be aggregated via secure interface busses 125, for analysis by a managing entity of building 105A; additionally or alternatively, the cross-sectional data pertaining to building 105A may be accessed, via secure interface busses 125, by approved management entities for either of buildings 105B and 105C for further comparison, analysis, and/or visualization.

Operating System (OS) 135 may refer to the computing platform on which applications, services, and other capabilities pertaining to data capable of being stored to, analyzed on, and retrieved from, database 140, may be built.

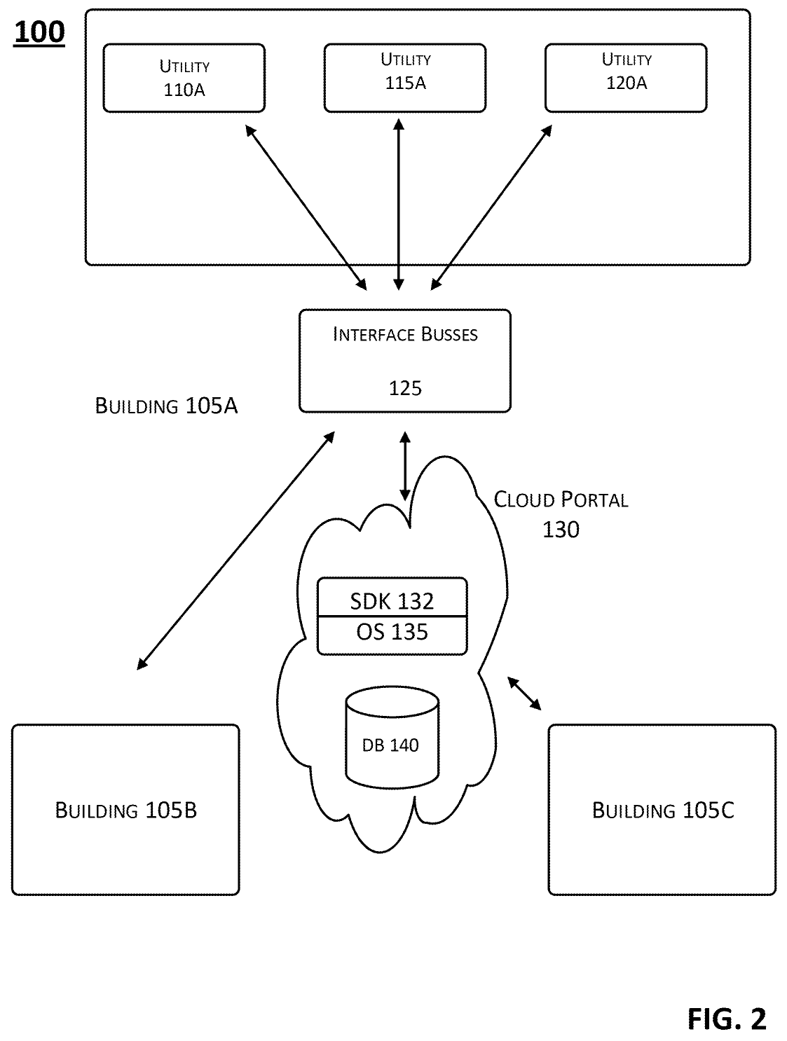

FIG. 2 shows a block diagram representing another configuration of example system 100 by which smart building data may be accessed aggregated, analyzed, and disseminated, arranged in accordance with at least some embodiments described and recited herein. As depicted, system 100 again includes at least plural buildings 105A, 105B, and 105C; and cloud portal 130. Building 105A, as an example only, may include services 110A, 115A, and 120B, and interface busses 125. Cloud portal 130, as an example only, may include SDK 132, Operating System (OS) 135, and database 140. Again, although illustrated as discrete entities and/or components, the features shown and described may be divided into additional entities and/or components, combined into fewer entities and/or components, or eliminated altogether while being contemplated within the scope of the disclosed subject matter.

The non-limiting example configuration of system 100 shown in FIG. 2 differs from that in FIG. 1, in that system 100 in FIG. 2 shows that interface busses 125 may be disposed external to all of buildings 105. Accordingly, interface busses 125 may be agnostic to system architectures implemented by management entities of buildings 105, but accessed by leveraging APIs provided by SDK 132.

Additionally, or alternatively, interface busses 125 may be disposed within more than one of buildings 105. Accordingly, interface busses 125 may comply with a particular network architecture implemented by a management entity of, e.g., building 105A and building 105B, since more than one of buildings 105 may owned and/or managed by a common entity.

Thus, in accordance with the non-limiting example of FIG. 2, cross-sectional data for services 110A, 115A, and 120A may be aggregated, analyzed, and/or visualized for building 105A.

By one non-limiting example, an ownership and/or management entity corresponding to building 105B may connect directly to one or more of interface busses 125 to respectively access data corresponding to service 110A, service 115A, and/or service 120A. Further, a management entity corresponding to building 105C may access database 140, via cloud portal 130, to view the data corresponding to services 110A, 115A, and/or service 120A, as stored in database 140, and/or an analysis and visualization thereof.

Non-limiting examples of data transmitted via interface busses 125 may pertain to efficiency of the provision of services 110, 115, and/or 120 to one or more of buildings 105, performance of one or more loT components in one or more of buildings 105, security monitoring in one or more of buildings 105 (e.g., quantities of people in a building, clustering of people in a particular section of a building, etc.). The examples provided herein are given to provide just a sense of the extensive possibilities thereof for the management and operation of any one of buildings 105.

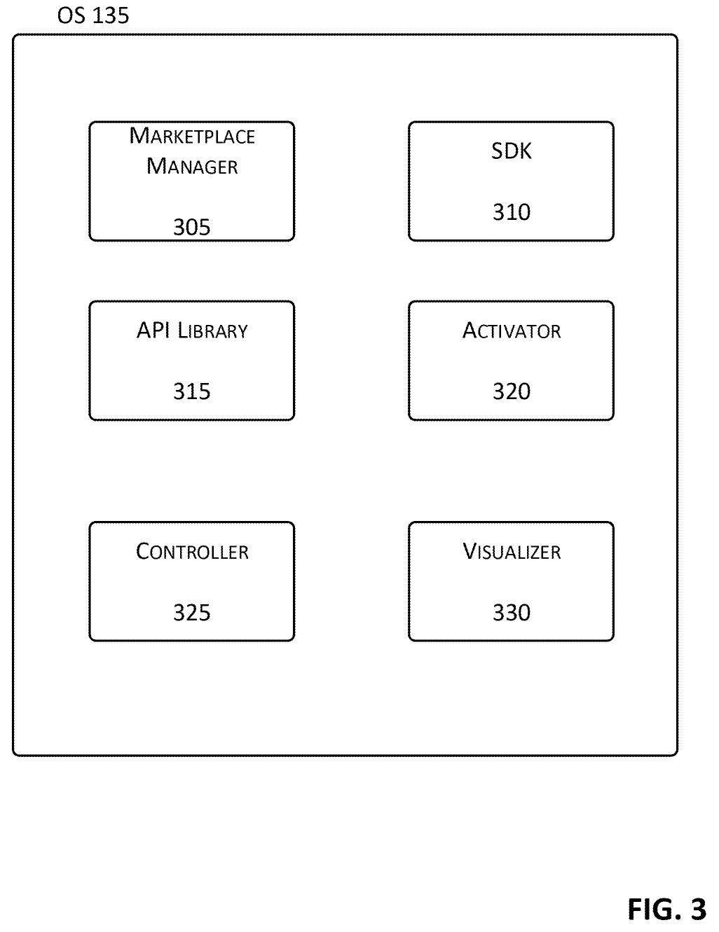

FIG. 3 shows an example operating system by which smart building data may be accessed aggregated, analyzed, and disseminated, arranged in accordance with at least some embodiments described and recited herein. As depicted, OS 135 may include at least marketplace manager 305, SDK 132, API library 315, activator 320, controller 325, and visualizer 330. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof.

Marketplace manager 305 may refer to a component that is designed, configured, or otherwise programmed to receive requests from one or more third-party vendors pertaining to one or more of, e.g., services 110, 115, and 120, intent on accessing cloud portal 130 to store or access data or retrieve analyzed data pertaining to one or more of any combination of buildings 105 or services 110, 115, and 120.

Subscriptions or authorization to one or more of interface busses 125 and/or cloud portal 130 may be provided in various permutations. As non-limiting examples, subscriptions or authorization may be based on vendor capabilities, e.g., building management; subscriptions or authorizations may be based on services provided by a respective third-party vendor, e.g., separate subscriptions or authorizations for water providers, electricity providers, internet service providers, security providers, police, fire and rescue, etc.; additionally or alternatively, subscriptions or authorizations may be granted in various combinations of those described above.

SDK 132 may refer to an installable package of software components that are designed, configured, or otherwise programmed to enable subscribing or otherwise authorized third-party vendors to access one or more of interface busses 125, as well as cloud portal 130, to thereby store data to and retrieve data from database 140. The subscription or authorization further provide access various permutations of analyses and/or visualizations of data stored to database 140 and other functionalities implemented by applications built on OS 135.

API library 315, which may be provided along with SDK 132 or provided separately, may be utilize as development tool by which a subscribing or authorized third-party vendor may download to, e.g., access one or more interface busses 125, interface with cloud portal 130, interact with applications built on OS 135 regarding analyses and visualization of data aggregated by, stored on, and analyzed in database 140. Utilizing one or more of the APIs, subscribing or otherwise authorized third-party vendors may interact with database 140, via respective ones of secure interface busses 125, to e.g., store thereto or retrieve data therefrom. Further, utilizing one or more of the APIs, subscribing or otherwise authorized third-party vendors may access analyses or visualizations of the stored data; and/or utilize the stored, analyzed, and/or visualized data in a customized application built on OS 135.

In at least some example embodiments of OS 135, API library 315 may be downloadable, along with SDK 132, to subscribers, compartmentalized so that portions thereof may be made available to subscribers in accordance with rights afforded to particular subscription types. As non-limiting examples, subscribing or otherwise authorized water service providers may access and utilize APIs that provide access to respective ones of interface busses 125 to securely access data stored in database 140 that pertains only to water services in any of buildings 105; additionally or alternatively, building management service providers may access and utilize APIs to securely access to respective ones of interface 125 that provide access to data stored in database 140 pertaining to multiple services in any of buildings, as well as analyses and/or visualizations of such stored data.

Activator 320 may refer to a component that is designed, configured, or otherwise programmed to receive and act upon an activation request for functionality enabled by development tools provided in SDK 132, including APIs from API library 315. Activator 320 may implement various levels of secure activation of functionality related to applications provided by or built on OS 135, including but not limited to entry of a product or vendor identifier. The example embodiments described and recited herein may contemplate usage of both known and conceivable implementations of activation protocols that provide secure brokerage of data, including both transmission and storage thereof.

Controller 325 may refer to a component that is designed, configured, or otherwise programmed to control access to database 140 for subscribing or otherwise authorized users.

Visualizer 330 may refer to an analysis component that is designed, configured, or otherwise programmed to provide any of a variety of analyses of real time data and or data stored on database 140 and, further, provide any of a variety of visualizations of such analyses for consideration and reaction by subscribing or otherwise authorized users. Access to such visualizations may be provided to subscribers or otherwise authorized vendors in accordance with corresponding APIs.

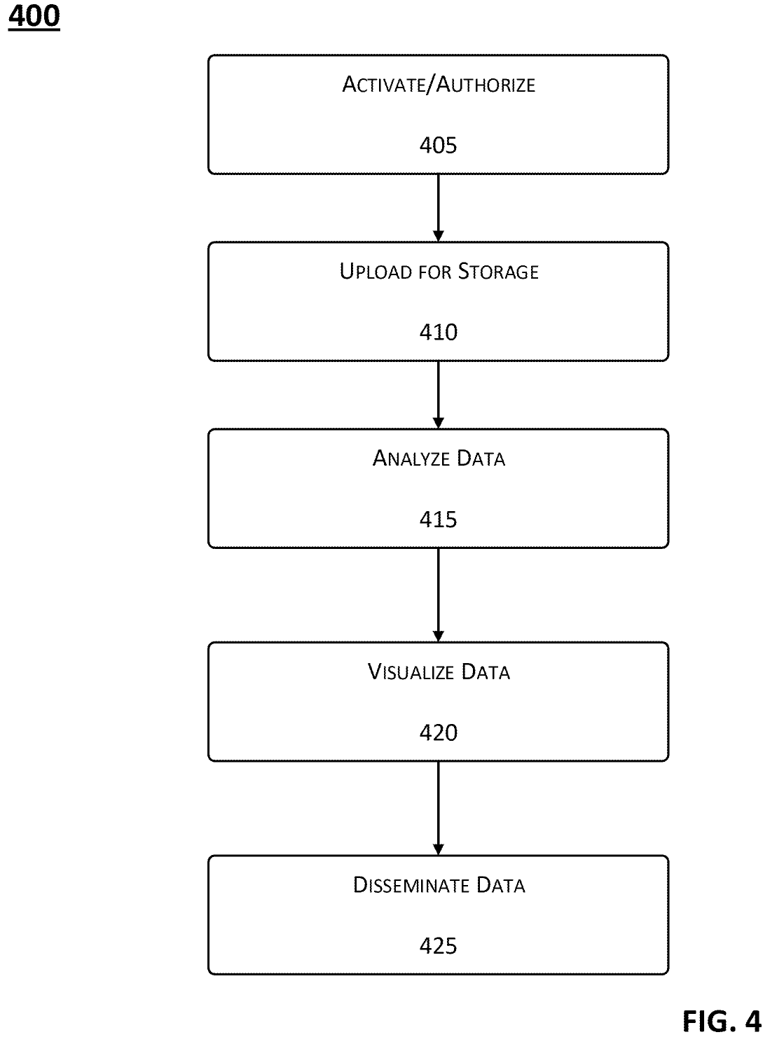

FIG. 4 shows an example operational flow by which smart building data may be accessed aggregated, analyzed, and disseminated, arranged in accordance with at least some embodiments described and recited herein. As depicted, processing flow 400 includes operations, sub-processes, or functionality executed by various components of OS 135 or at least associated with various functionalities thereof. However, operational flow 400 is not limited to such components and processes, as obvious modifications may be made by re-ordering two or more of the sub-processes described here, eliminating at least one of the processes or functions, adding other processes or functions, substituting components, or even having various components assuming sub-processing roles accorded to other components in the following description. Operational flow 400 may include various operations, functions, or actions as illustrated by one or more of blocks 405, 410, 415, 420, and 425. These various operations, functions, or actions may, for example, correspond to software, program code, or program instructions executable by a digital processor that causes the functions to be performed. Operations may begin at block 405.

At block 405 (Activate/Authorize), activator 320 may receive a request for activation of functionality provided by development tools associated with SDK 132, which may include API library 315. Accordingly, upon activation and in accordance with the respectively utilized APIs, a subscribing or otherwise authorized third-party vendor may have secure access to one or more of interface busses 125 and/or secure access to cloud portal 130. Operational flow 400 may proceed to block 410.

At block 410 (Upload for Storage), data may be transmitted to database 140 for storage. The data may be transmitted via one or more of interface busses 125, for which secured access is procured by an API included in SDK 132. Operational flow 400 may proceed to block 415.

At block 415 (Analyze Data), data securely transmitted to and stored in database 140 may be analyzed in accordance with one or more of a variety of applications built upon OS 135. The applications for analyses may be built on OS 135 by a proprietor of the infrastructure for interface busses 125 and components corresponding to cloud portal 130 and database 140. In addition or in the alternative, the applications for analyses may be built on OS 135 by any one or more of the subscribing or otherwise authorized third-party vendors that have secure access via cloud portal 130. Operational flow 400 may proceed to block 420.

At block 420 (Visualize Data), data securely stored in database 140 and analyzed by one or more applications built on OS 135 may be subject to web-based visualization tool that may provide an actionable representation of data that may be customized based on a corresponding subscription or authorization. The output of the visualization may be regarded as property analytics that presents, e.g., past and current performance, projected performance, and recommendations to achieve or even improve upon the current and projected performance, and therefore one or more applications built on OS 135 may provide tools for authorized or automated responses to the analysis in the form a textual or visual recommendation or as an automated action pertaining to the allocation and/or usage of resources in one or more of buildings 105. Accordingly, the visualization of data, as described and recited herein, may pertain to data received in real-time or data that is recorded and stored on OS 135.

The visualization tools may be built on OS 135 by the proprietor of the infrastructure for interface busses 125 and components corresponding to cloud portal 130 and database 140. In addition or in the alternative, the visualization tools may be built on OS 135 by any one or more of the subscribing or otherwise authorized third-party vendors that have secure access via cloud portal 130. Operational flow 400 may proceed to block 425.

At block 425 (Disseminate Data), the analyzed and/or visualized data may be transmitted to one or more of the subscribing or authorized third-party vendors, in accordance with the corresponding subscriptions or authorizations, or the analyzed/visualized data may be stored for subsequent transmission to a present or future subscriber or vendor. Further, the transmission may be pushed or pulled, again in accordance with the corresponding subscriptions or authorizations.

Operational flow 400 may continuously loop in various permutations.

An implementation of the components described and recited herein with regard to FIGS. 3 and 4 may be stored on or transmitted across some form of computer readable media, which may be regarded as any available media that may be accessed by a processing device. As a non-limiting example, computer readable media may comprise “computer storage media” and “communications media.” Further, “computer storage media” may include volatile and non-volatile, removable and nonremovable media implemented in any method or technology for storage of information such as computer readable instructions, data structures, program modules, or other data. Computer storage media includes, but is not limited to, RAM, ROM, EEPROM, flash memory or other memory technology, optical storage, disk storage or other magnetic storage devices, or any other medium which may be used to store the desired information and which can be accessed by a processor. Further still, “communication media” may typically embody computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above may also be included within the scope of computer readable media.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A computer-readable medium storing executable instructions that, upon execution, cause a processor to perform functions comprising:
receive an activation request from a subscribing entity;
authorize secure access to one or more interface busses and corresponding secure access to a smart building platform for the subscribing entity in accordance with one or more application programming interfaces (APIs) corresponding to an authorized software development kit (SDK), the APIs including permissions to:
upload data for storage to an authorized smart building cloud portal endpoint via one or more of the interface busses, and
access at least portions of the stored data stored, wherein the accessed data includes the uploaded data, data uploaded by another source, analyzed data uploaded from multiple sources, or visual representations thereof.

2. The computer-readable medium of claim 1, wherein the API further includes permissions for subscribing entities to build applications on the smart building platform.

3. The computer-readable medium of claim 2, wherein the subscribing entities are owners or managers of separate buildings.

4. The computer-readable medium of claim 2, wherein the subscribing entities are service providers.

5. The computer-readable medium of claim 4, wherein the service providers include HVAC providers or gas and electricity providers.

6. A computer-readable medium for a smart building development platform having computer-executable components stored therein, the computer-executable components comprising:
an activator to secure access to one or more interface busses and corresponding secure access to a smart building platform for the subscribing entity in accordance with one or more application programming interfaces (APIs) corresponding to an authorized software development kit (SDK);
a controller to control access to data on the smart building platform via one or more of the secured interface busses;
an analyzer to execute programmed analysis of the uploaded data; and
a visualizer to produce visualizations of the analyzed data.

7. The computer-readable medium of claim 6, wherein the APIs provide permissions for a third-party to access the smart building platform.

8. The computer-readable medium of claim 6, wherein the APIs are adaptable to multiple system architectures.

9. The computer-readable medium of claim 7, wherein the smart building platform is managed by an owner or manager of a first property and the third-party is an owner or manager of a different property.

10. The computer-readable medium of claim 7, wherein the smart building platform is managed by an owner or manager of a first property and the third-party is an owner or manager of a different property.

11. The computer-readable medium of claim 7, wherein the third-party is a service provider.

12. The computer-readable medium of claim 8, wherein the controller provides access for the storage of unstructured data, time-series data, graph-oriented data, and relational data.

13. The computer-readable medium of claim 8, wherein the controller controls access, via the interfaces busses, to data stored on the platform that includes data uploaded by a third-party, the analyzed data, and the visualized data.
